(19) United States
(12) Patent Application Publication
(10) Pub. No.: US 2008/0085726 A1
(43) Pub. Date: Apr. 10, 2008

(54) Diversified tracking-positioning system and its operation method

(76) Inventor: Hong-Fu Li, Banchiau City (TW)

Correspondence Address: Troxell Law Office PLLC, Suite 1404, 5205 Leesburg Pike, Falls Church, VA, 22041, US

(21) Appl. No.: 11/544,025

(22) Filed: Oct. 6, 2006

(51) Int. Cl. H04Q 7/20

(52) U.S. Cl. 455/456.1

(57) ABSTRACT

A diversified tracking-positioning system and its operation method refer specially to a tracking-positioning system of a strategic alliance of satellite and telecommunication vendors. The tracking-positioning system combines primarily the satellite vendor with the telecommunication vendor, and further obtains a geographic position of a locked-on person through configuring a SIM card of user's cellular phone, followed by transmitting the geographic position to pre-configured telephone subscribers through sending a news brief, such that the geographic position of locked-on person can be quickly found out to proceed with a searching or rescuing.

### BACKGROUND OF THE INVENTION

(a) Field of the Invention

The present invention relates to a diversified tracking-positioning system and its operation method, and more particularly to a tracking-positioning system of a strategic alliance of satellite and telecommunication vendors, whereby a geographic position of a person who has been locked on is obtained through a SIM card location of a cellular phone.

(b) Description of the Prior Art

In terms of the existing social environment, the human being is gradually toward agedness that many aged people will have an issue of Alzheimer's disease, and that a problem of stray of aged people will be gradually severe.

In addition to the problem of aged people, ordinary parents are too busy in working that they cannot stay with toddlers or children, let alone are aware of whereabouts of the toddlers or children, thereby causing many problems such as that children are missing, running away, or even swindled by fraud groups.

These problems are often a major issue to be faced by a civilized society. Therefore, under the existing environment of technology development, to facilitate a quick contact with the aged people, toddlers, or children, many parents or offspring will subscribe a set of cellular phone number for the elder, toddler, or child at home, in order to acquire a condition of the elder, toddler, or child at any time through a communication with the cellular phone. However, for this method, the elder, toddler, or child should be able to describe his or her geographic position by oneself. Therefore, if there is a circumstance that he or she is lost, cannot recognize a road condition, or even gets lost in a mountain area, the elder, toddler, or child will not be able to identify his or her position, which results in a failure to proceed with a search or rescue quickly.

The existing search or rescue method requires primarily parents or relatives to call a police who will acquire information of the calling place from a telecommunication vendor, and will then proceed with a search or rescue for the elder, toddler, or child along with a rescue crew, according to the information of calling place provided by the telecommunication vendor, which not only wastes a lot of time, but also delays the time of rescue.

Nevertheless, for the ordinary telecommunication vendors, there are still many places which cannot be covered in usage, such as on a sea, in air, or in a remote mountain area. Fortunately, there are satellite phones at moment, to proceed with a signal transmission (known as the Iridium project) primarily through a satellite communication, thereby enabling a wireless communication method to be more comprehensive.

For the current development, in addition to that a traditional telecommunication vendor or a satellite phone vendor can be chosen respectively for the ordinary wireless communication, a consumer can also select the wireless communication method that both the traditional telecommunication vendor and the satellite phone vendor can use.

Accordingly, how to provide a fast and accurate tracking-positioning system which combines the traditional telecommunication vendor with the satellite phone vendor is an issue to be solved by the present invention.

### SUMMARY OF THE INVENTION

The primary object of present invention is to use a mutual combination of a tracking-positioning system with a telecommunication vendor, such that a geographic position of a person who has been locked on can be acquired through a cellular phone, and can be transmitted using a news brief method through the telecommunication vendor, thereby enabling a user to quickly obtain the geographic position of locked-on person to achieve an effect of fast searching or rescuing.

Accordingly, in order to achieve the aforementioned object, the present invention provides a diversified tracking-positioning system and its operation method including primarily a system host, a client database, and a geographic information system database. In addition, the system host is interlinked with a database of telecommunication vendor, a text news-brief transmitting end, and a satellite phone vendor, after being approved by the telecommunication vendor (the telecommunication vendor can be a vendor of ordinary cellular phone or a satellite phone vendor which rises currently).

Owners of a set or plural sets of cellular phone numbers configure a cellular phone subscriber to be locked on, to constitute a network from the owners and the subscriber, such that the owners can dial to the system host for comparing with the client database in order to acquire the network data which is composed of the owners of cellular phone numbers, enabling the system host to quickly access the data of locked-on cellular phone subscriber, and then to communicate with the telecommunication vendor who will provide a base station closest to the cellular phone subscriber. Therefore, the system host can compare the base station data of telecommunication vendor with the geographic information system database to acquire the geographic position of locked-on cellular phone subscriber for transmitting to the text news-brief transmitting end of telecommunication vendor who will then transmit the geographic position using the news brief to the owners of cellular phone numbers, such that all of the owners can have the geographic position of locked-on cellular phone subscriber. In the mean time, if the owner of cellular phone number who calls a service end is still dialoging with the service end, the geographic position will be notified in a voice message to the caller of owners of cellular phone numbers, through the system host at the service end.

However, if the telecommunication vendor is not able to link with the locked-on cellular phone subscriber, the system host will transfer the data of locked-on cellular phone subscriber to the satellite phone vendor who will search for the geographic position of locked-on cellular phone subscriber using a satellite communication method, and then transmit to the system host for comparing with the geographic information system database, so as to transmit the correct geographic position to the owners of cellular phone numbers.

Accordingly, when the locked-on cellular phone subscriber is in an area which can be covered by the telecommunication vendor, his or her geographic position can be available through the ordinary cellular phone. However, if the locked-on cellular phone subscriber is out of the area which can be covered by the telecommunication vendor, such as on a sea, in air, or in a remote mountain area, his or her correct geographic position can be available through the satellite communication, such that a failure to determine the geographic position of locked-on cellular phone subscriber can be prevented.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a system of the present invention.

FIG. 2 shows a schematic view of an embodient of a first operation method of the present invention.

FIG. 3 shows a schematic view of an embodient of a second operation method of the present invention.

### DETAILED DESCRIPTION OF THE PREFERRED EMBODIMENTS

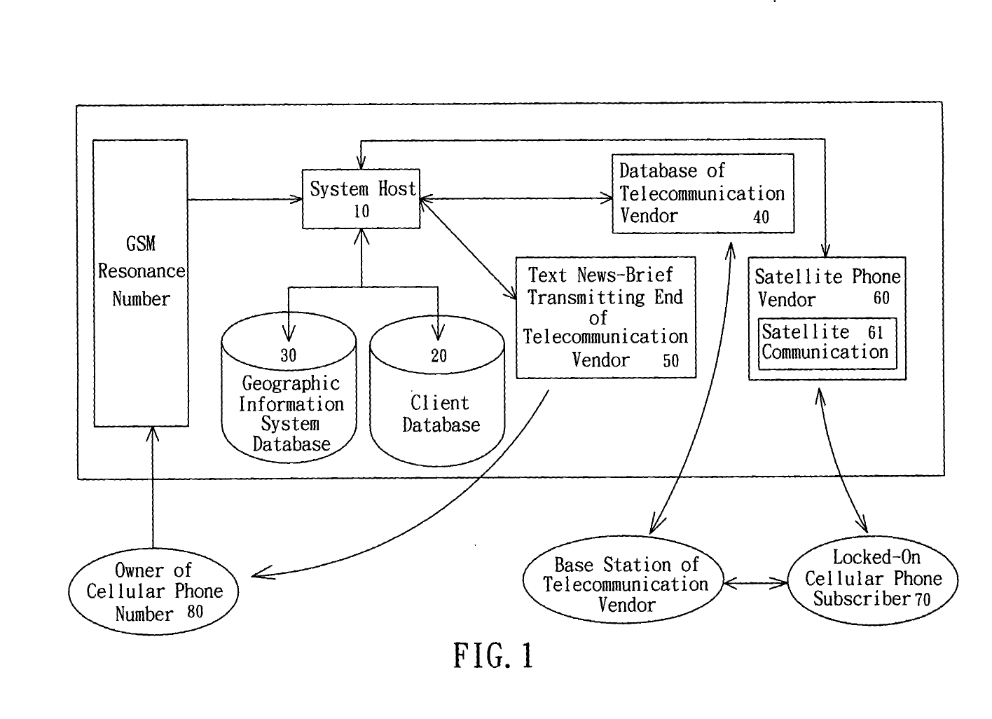

Referring to FIG. 1, a tracking-positioning system of the present invention comprises primarily a system host 10, a client database 20, and a geographic information system database 30, wherein after the system host 10 has obtained an approval from a telecommunication vendor and a satellite phone vendor, it is linked to a database of telecommunication vendor 40, a text news-brief transmitting end of the telecommunication vendor 50, and the satellite phone vendor 60, respectively, whereas the satellite phone vendor 60 proceeds with a signal transmission through a satellite communication method 61.

A subscriber can obtain a cellular phone number through a wireless phone communication vendor including the telecommunication vendor and satellite phone vendor, and a locked-on cellular phone subscriber 70 asks the wireless phone communication vendor to configure owners of a set or plural sets of cellular phone numbers 80, to form a network. Next, the network data is stored into the client database 20, and the system host 10 provides a set or plural sets of service numbers, enabling the owners of cellular phone numbers 80 to directly dial the service numbers to link to the system host 10, thereby constituting a tracking-positioning system.

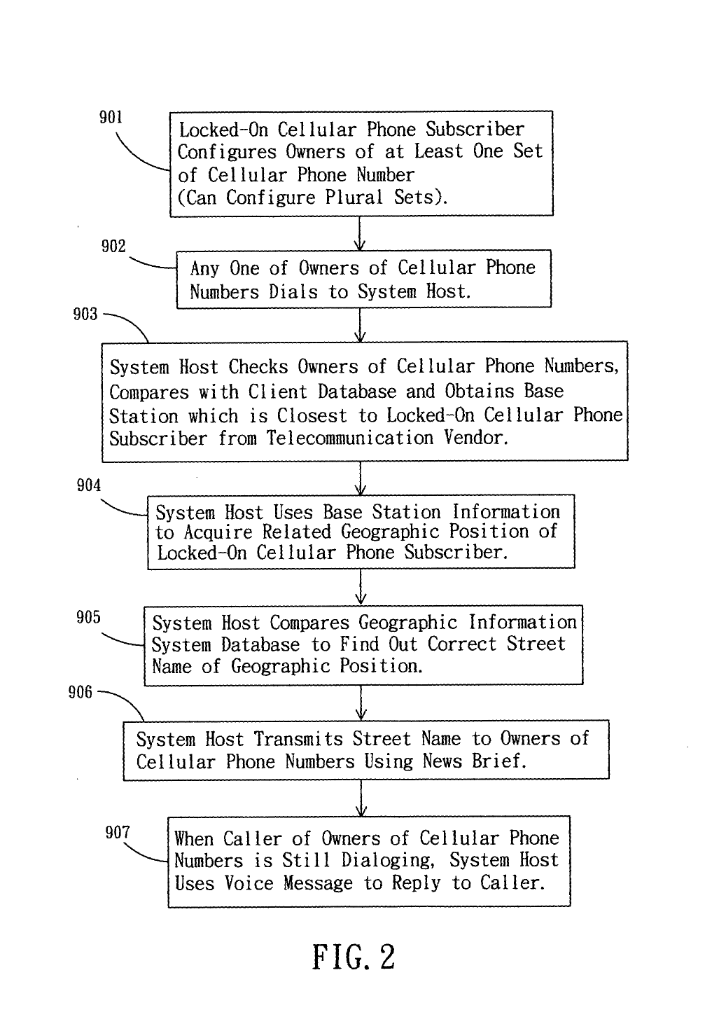

Referring to FIG. 2, it shows an operation procedure of the present invention using the traditional telecommunication vendor to proceed with the tracking and positioning; the procedure includes the following steps:

Step 1 901: The locked-on cellular phone subscriber asks the telecommunication vendor to configure the owners of one set or plural sets of cellular phone numbers, so as to constitute the network by the owners of cellular phone numbers and the locked-on cellular phone subscriber, and to log the network data into the client database.

Step 2 902: Any one of the owners of cellular phone numbers dials the service number to link to the system host.

Step 3 903: After the system host has acquired the data of owner of cellular phone number who dials the service number, it immediately enters into the client database for comparison, to acquire the data of locked-on cellular phone subscriber who is networked with the owners of cellular phone numbers, and then to transmit the data of locked-on cellular phone subscriber to the database of telecommunication vendor for searching for a closest base station according to the data of cellular phone subscriber.

Step 4 904: After the base station data is obtained from the database of telecommunication vendor, it is transmitted to the system host for obtaining the geographic position of locked-on cellular phone subscriber through the base station (in this embodient, the geographic position is a coordinate bearing).

Step 5 905: After the system host has acquired the geographic position of locked-on cellular phone subscriber, it enters into the geographic information system database for comparison, to find out a detailed street name of the geographic position.

Step 6 906: The system host transmits the street name found out from the geographic information system database to the text news-brief transmitting end of telecommunication vendor, which in turn transmits the street name using the news brief to the owners of cellular phone numbers, such that the owners of cellular phone numbers can obtain the correct position of locked-on cellular phone subscriber using a cellular phone.

Step 7 907: If the owners of one set or plural sets of cellular phone numbers who dial to the system host are still dialoging with the system host, the correct position of cellular phone subscriber will be notified in a voice message to the caller of owners of cellular phone numbers by the system host, enabling the owners of cellular phone numbers who dial to the system host to be quickly aware of the correct position of locked-on cellular phone subscriber.

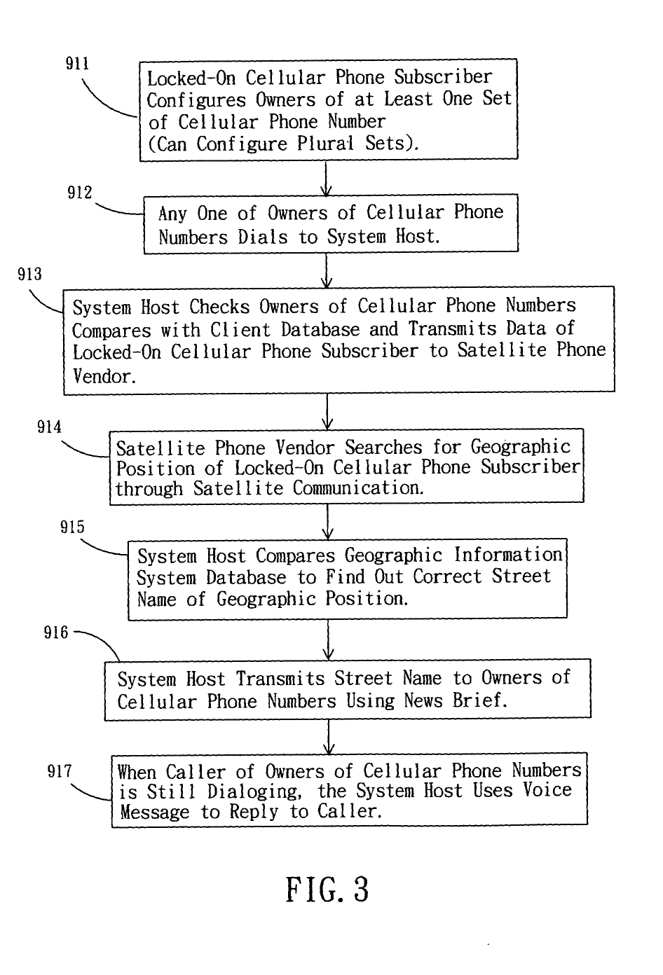

If the telecommunication vendor is not able to communicate with the locked-on cellular phone subscriber through the base station, the system host will further transmit the data of locked-on cellular phone subscriber to the satellite phone vendor for communicating with the cellular phone subscriber. The detailed operation method is referred to FIG. 3, showing the operation procedure of present invention using the satellite phone vendor to proceed with the tracking and positioning, which includes the following the steps:

Step 11 911: The locked-on cellular phone subscriber asks the telecommunication vendor to configure the owners of one set or plural sets of cellular phone numbers, so as to constitute the network by the owners of cellular phone numbers and the locked-on cellular phone subscriber, and to log the network data into the client database.

Step 12 912: Any one of the owners of cellular phone numbers dials the service number to the system host.

Step 13 913: After the system host has acquired the data of owner of cellular phone number who dials the service number, it immediately enters into the client database for comparison, to obtain the data of locked-on cellular phone subscriber who is networked with the owners of cellular phone numbers, and then to transmit the data of locked-on cellular phone subscriber to the satellite phone vendor.

Step 14 914: The satellite vendor acquires the geographic position (in this embodient, the geographic position is a coordinate bearing) of locked-on cellular phone subscriber through the satellite communication method and reports back to the system host.

Step 15 915: After the system host has acquired the geographic position of locked-on cellular phone subscriber, it enters into the geographic information system database for comparison, to find out the detailed street name from the geographic information system database.

Step 16 916: The system host transmits the street name found out from the geographic information system database to the satellite phone vendor who in turn transmits the street name using the news brief to the owners of cellular phone numbers, enabling the owners of cellular phone numbers to obtain the correct position of locked-on cellular phone subscriber using a cellular phone.

Step 17 917: If the owners of cellular phone numbers who dial to the system host are still dialoging with the system host, the correct position of cellular phone subscriber will be notified in a voice message to the caller of owners of cellular phone numbers by the system host, enabling the owner of cellular phone number who dials to the system host to be quickly aware of the correct position of locked-on cellular phone subscriber.

Therefore, when the cellular phone subscriber in present invention is the elder or child, the cellular phone number can belong to a relative, such as a parent of child, or an offspring, such that the correct position of elder or child can be quickly obtained through a simple dialing action by the tracking-positioning system of present invention, thereby being aware of the whereabouts of elder or child, to prevent him or her from getting lost.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A diversified tracking-positioning system comprising a system host which is mutually linked with a database of telecommunication vendor, a text news-brief transmitting end of the telecommunication vendor, and a satellite phone vendor, after being approved by the telecommunication vendor and the satellite phone vendor; a client database which stores a shared cellular phone number that is obtained by a subscriber from the telecommunication vendor and the satellite phone vendor, and which allows the locked-on cellular phone subscriber to configure owners of a set or plural sets of cellular phone numbers for constituting a network data; and a geographic information system which is used for comparing a geographic position of the locked-on cellular phone subscriber obtained by the telecommunication vendor and the satellite phone vendor, in order to search for the correct position of the cellular phone subscriber.

2. The diversified tracking-positioning system according to claim 1, wherein the geographic position is a coordinate bearing.

3. An operation method of a diversified tracking-positioning system comprising the following steps:
step 1: the locked-on cellular phone subscriber asking the satellite phone vendor to configure the owners of one set or plural sets of cellular phone numbers;
step 2: any one of the owners of cellular phone numbers dialing the service number to the system host;
step 3: the system host checking the data of owner of cellular phone number, comparing with the client database, and transmitting the data to the satellite phone vendor;
step 4: the satellite phone vendor obtaining the geographic position of locked-on cellular phone subscriber through the satellite communication, and reporting back to the system host;
step 5: the system host comparing the geographic information system database to find out a detailed street name of the geographic position;
step 6: the system host transmitting the street name that is found from the geographic information system database to the satellite phone vendor who will then transmit the street name to the owners of cellular phone numbers using the news brief, enabling the owners of cellular phone numbers to obtain the correct position of locked-on cellular phone subscriber from a cellular phone.

4. The operation method of a diversified tracking-positioning system according to claim 3, further comprising the following step:
step 7: if the owners of cellular phone numbers who dial to the system host still dialoging with the system host, the correct position of cellular phone subscriber being notified in a voice message to the owners of cellular phone numbers at the dialoging state by the system host, enabling the owners of cellular phone numbers who dial to the system host to be quickly aware of the correct position of locked-on cellular phone subscriber.

5. The operation method of a diversified tracking-positioning system according to claim 3, wherein the geographic position is a coordinate bearing.

6. An operation method of a diversified tracking-positioning system comprising the following steps:
step 1: the locked-on cellular phone subscriber asking the telecommunication vendor and the satellite phone vendor to configure the owners of a set or plural sets of cellular phone numbers;
step 2: any one of the owners of cellular phone numbers dialing the service number to the system host;
step 3: the system host checking the data of owner of cellular phone number, comparing with the client database, and transmitting the data to the telecommunication vendor; if the telecommunication vendor being unable to communicate with the locked-on cellular phone subscriber, the system host transmitting the data to the satellite phone vendor;
step 4: if the telecommunication vendor obtaining the geographic position of locked-on cellular phone subscriber through the base station, the telecommunication vendor reporting the geographic position back to the system host; if the satellite phone vendor obtaining the geographic position of locked-on cellular phone subscriber through the satellite communication, the satellite phone vendor reporting the geographic position back to the system host;
step 5: the system host comparing the geographic information system database to find out a detailed street name of the geographic position;
step 6: the system host transmitting the street name that is found from the geographic information system database to the telecommunication vendor or the satellite phone vendor who receives the geographic position of locked-on cellular phone subscriber, to transmit the street name to the owners of cellular phone numbers using the news brief, enabling the owners of cellular phone numbers to obtain the correct position of locked-on cellular phone subscriber from a cellular phone.

7. The operation method of a diversified tracking-positioning system according to claim 6, further comprising the following step:
step 7: if the owners of cellular phone numbers who dial to the system host still dialoging with the system host, the correct position of cellular phone subscriber being notified in a voice message to the owners of cellular phone numbers at the dialoging state by the system host, enabling the owners of cellular phone numbers who dial to the system host to be quickly aware of the correct position of cellular phone subscriber.

8. The operation method of a diversified tracking-positioning system according to claim 6, wherein the geographic position is a coordinate bearing.
